(19) United States
(12) Patent Application Publication
(10) Pub. No.: US 2013/0036352 A1
(43) Pub. Date: Feb. 7, 2013

(54) SIMPLIFYING THE PROCESS OF CREATING XML DOCUMENT TRANSFORMATIONS

(71) Applicants: Joshua W. Hui, San Jose, CA (US); Peter M. Schwarz, San Jose, CA (US)

(72) Inventors: Joshua W. Hui, San Jose, CA (US); Peter M. Schwarz, San Jose, CA (US)

(73) Assignee: INTERNATIONAL BUSINESS MACHINES CORPORATION, Armonk, NY (US)

(21) Appl. No.: 13/596,366

(22) Filed: Aug. 28, 2012

Related U.S. Application Data
(63) Continuation of application No. 13/197,584, filed on Aug. 3, 2011.

(51) Int. Cl. G06F 17/00

(52) U.S. Cl. 715/234

(57) ABSTRACT

A method for simplifying a process for creating a transformation of an extensible markup language XML document is described. The method includes: creating a target model by incremental user selection of elements in a source model; interpreting the target model to create an XML schema of the target model; and creating a mapping between the source model of the XML document and the target model, wherein the mapping is stored on a memory device.

### CROSS-REFERENCE TO RELATED APPLICATIONS

This application is a continuation of U.S. application Ser. No. 13/197,584, filed on Aug. 3, 2011, which is incorporated by reference herein in its entirety.

### BACKGROUND

Extensible markup language (XML) documents generated in the course of doing business often contain data collected for disparate purposes. When data in archived XML documents is required for some specific purpose, data relevant to the specific purpose from a larger body of information represented by the complete documents may be extracted to produce a smaller, simpler data set whose structure is tailored for the data's intended use.

Various tools exist to assist users in transforming XML documents from one form to another. Some conventional tools can be time consuming, difficult, and highly subject to errors. More sophisticated tools utilize XML schemas to describe the structure of source and target documents. However, the more sophisticated tools can introduce new sources of complexity and/or error into the overall document transformation process via construction of a target schema.

### SUMMARY

Embodiments of a method are described. In one embodiment, the method is a method for simplifying a process for creating a transformation of an extensible markup language XML document. The method includes: creating a target model by incremental user selection of elements in a source model; interpreting the target model to create an XML schema of the target model; and creating a mapping between the source model of the XML document and the target model, wherein the mapping is stored on a memory device. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of an extensible markup language (XML) document transformation system.

FIG. 2 depicts a schematic diagram of one embodiment of a document structure conforming to a source XML schema.

FIG. 3 depicts a schematic diagram of one embodiment of a semantic data structure for the document structure of FIG. 2.

FIG. 4 depicts a schematic diagram of one embodiment of a target model.

FIG. 5 depicts a schematic diagram of one embodiment of a target model.

FIG. 6 depicts a schematic diagram of one embodiment of the user interface of FIG. 1.

FIG. 7 depicts a flow chart diagram of one embodiment of a method for simplifying a process for creating a transformation of the XML document transformation system of FIG. 1.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a system and method for simplifying the process of creating transformations of an extensible markup language (XML) document. More specifically, the system provides a user interface for a user to create a customized XML model based on a semantic data structure of a source model for the XML document, such that the XML document may be transformed to conform to the customized XML model. The system also generates a mapping that can be used with conventional tools to automatically generate an implementation of the desired transformation.

Some primitive conventional tools for transforming XML documents from one form to another require transformations to be coded in a language suitable for manipulating XML. Hand-coding transformations in such languages can be time-consuming, difficult, and highly subject to errors. More sophisticated tools utilize XML schemas to describe the structure of the source and target documents. These tools may require the user to make connections, referred to as correspondences, between elements of the source document schema and elements of the target document schema. Correspondences represent the intended transfer of data of interest in document instances, and are used to create a mapping from the source to the target. Once a mapping has been specified, an implementation of the desired transformation may automatically be produced.

However, the reliance of some conventional tools on XML schemas to describe the source and target documents introduces new sources of complexity and error. First, the XML schema for the source documents may be very general, and may support many document structures that do not appear in the collection to be transformed. This may lead the user to create unnecessary mappings for cases that never occur. Second, the element names in the source schema may be very generic, and give the user creating mappings little guidance as to the information they may contain. This makes it difficult to determine which data elements should be moved to the target model, and under what circumstances. Last, schema-based tools may require the precise structure desired for the transformed documents to be known in advance, and specified in terms of an XML schema. Consequently, construction of the target schema introduces other complex and error-prone tasks to the overall document transformation process.

The system and method described herein allow users to produce transformations for XML documents without relying solely on a source schema to describe the input documents, and without specifying a target schema up front. The target model may be constructed intuitively and incrementally. The system replaces the cumbersome and error-prone target tasks of developing the target schema and mapping with a more intuitive process that is straightforward enough to be realized by a simple user interface.

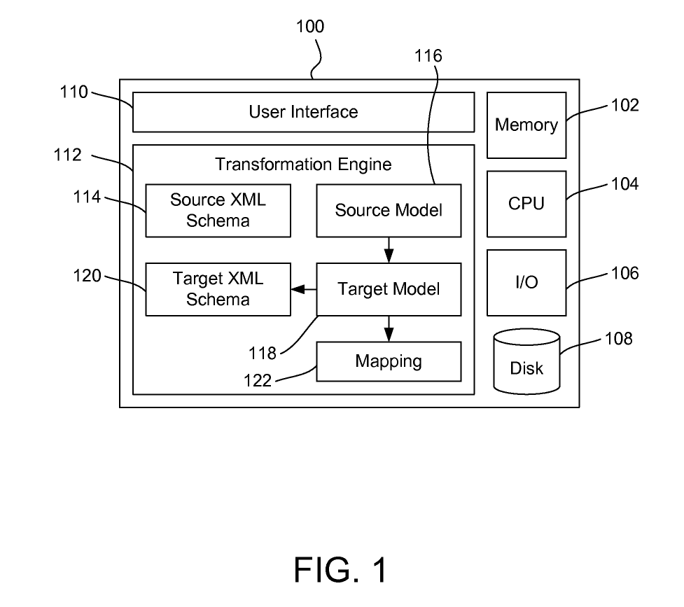

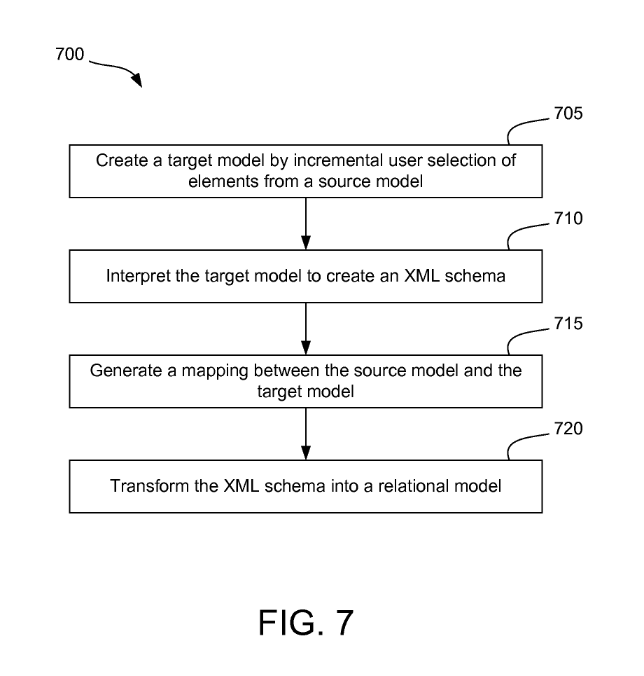

FIG. 1 depicts a schematic diagram of one embodiment of an XML document transformation system 100. The depicted XML document transformation system 100 includes various components, described in more detail below, that are capable of performing the functions and operations described herein. In one embodiment, at least some of the components of the XML document transformation system 100 are implemented in a computer system. For example, the functionality of one or more components of the XML document transformation system 100 may be implemented by computer program instructions stored on a computer memory device 102 and executed by a processing device 104 such as a CPU. The XML document transformation system 100 may include other components, such as a disk storage drive 106, input/output devices 108, a user interface 110, and a transformation engine 112. Some or all of the components of the XML document transformation system 100 may be stored on a single computing device or on a network of computing devices. The XML document transformation system 100 may include more or fewer components or subsystems than those depicted herein. In some embodiments, the XML document transformation system 100 may be used to implement the methods described herein as depicted in FIG. 7.

In one embodiment, the document transformation system 100 includes a user interface 110. The user interface 110 may be incorporated into a computing device with a display device, such that the user interface 110 is visible to a user. The user interface 110 may receive various inputs from the user. The user may interact with the user interface 110 to perform some of the operations for the system 100.

The system 100 also includes a transformation engine 112. Some or all of the operations of the system 100 may be performed by the transformation engine 112. In one embodiment, the system 100 first creates a specific source model 116 from a collection of documents. The source model 116 may be a structural summary of all of the source documents that conform to the source XML schema 114. Additional semantic information may be added to the source model 116 for ease of understanding and navigation. In another embodiment, the source model 116 is created in another system. The system 100 receives incremental selections of elements from the source model 116 and adds each selected element to the target model 118. A selected element may be any element from the source model 116. In one embodiment, the source model 116 is represented by a semantic data structure based on an XML schema for source documents. The target model 118 may be a model used to create a corresponding target XML schema 120.

In one embodiment, the semantic data structure is a Semantic Data Guide (SDG) as disclosed in “Method for Generating Statistical Summary of Document Structure to facilitate Data Mart Model Generation,” disclosed anonymously, IP.com number IPCOM000199141D, published Aug. 26, 2010, semantic data structure may aid the user in selecting source elements for mapping by using three types of information about the source documents that may not be provided by the source XML schema 114. The system 100 makes use of element names that are more descriptive than those provided by the XML schema, and which depend to some extent on the content of the input document. For example, an element named “observation” in the schema may be known to be a “Blood Pressure Observation” based on a code value found within the document. A document element whose value provides cues about the meaning of another element as a discriminator, and refers to the corresponding, more specifically named element (e.g., “Blood Pressure Observation”) is referred to herein as a discriminated element.

The system 100 also makes use of information about where each discriminated element appears within input documents. This information is represented in the form of a set of paths starting from a root of the document and leading to the element in question. In one embodiment, the paths are context paths. Some elements may occur in multiple contexts, but other elements defined in the XML schema may not occur at all in the input documents. Such elements may not need to be mapped, and are not presented to the user in the user interface 110.

In one embodiment, the system 100 also makes use of information about how often a particular element is repeated in the input documents. For example, the schema may allow a “person” element to contain multiple “Address” elements, but mappings 122 can sometimes be simplified. In another example, ambiguous mappings 122 can sometimes automatically be avoided if it is known that an “Address” element occurs at most once in certain contexts among the actual input documents. In one embodiment, the information used by the system 100 as described herein corresponds to the SDG created from the input documents. The SDG or other semantic data structure may be structured as a tree whose nodes correspond to context paths that may be found in one or more input documents.

The system 100 produces a target schema 120 and a mapping 122 linking the source schema 114 to the target schema 120, given user input of selected elements and the information from the semantic data structure. In one embodiment, the user indicates the selected elements via a drag-and-drop user interface 110. Once the target schema 120 and the mapping 122 have been created, schema-driven tools may be used to create an implementation of the mapping 122. The mapping 122 describes a transformation to be performed by means of a hierarchical nesting of correspondences between source elements and target elements.

For a pair of atomic elements (i.e., leaf nodes in the source and target schemas 120), a correspondence represents movement of data from the input element to the output element. For a pair of non-atomic elements, a correspondence contains nested correspondences for some or all of the sub-elements contained in the elements referenced by the correspondence. A correspondence may be refined with a condition that specifies under what circumstances data should be moved from source to target. A condition may also be used to filter occurrences of an element that may occur more than once. A condition may refer to the contents of elements anywhere in the source document(s), using absolute paths or paths relative to the source element of the correspondence that is being refined.

In one embodiment, the system 100 allows the user to select elements of interest from the source model 116 and insert them into an incrementally-created hierarchical target model 118 that represents the desired structure of the transformed documents. Elements from the source model 116 are designated by specifying the context path(s) in which they appear in source documents. The desired location of the element in the target model 118 is designated by specifying the parent node under which the selected element is to be inserted. Any descendant elements of the selected element from the source model 116 become descendant elements of the selected element in the target model 118. In one embodiment, the user is able to create empty nodes in the target model 118 to which elements from the source model 116 may be added.

In one embodiment nodes in the target model 118 are divided into three groups. Nodes that represent elements explicitly selected from the semantic data structure and are inserted into the target model 118 are source nodes. Nodes that are descendants of a source node, and were thus implicitly added to the target model 118 when the source node was added, are source descendant nodes. Nodes without a corresponding source element, i.e., those created explicitly in the target model 118, are local nodes.

Non-local nodes in the target model 118 are therefore associated with a specific node in the semantic data structure that determines whether or not the element represented by the target should be instantiated when a source document is mapped to the target model 118, and also determines the number of instances of the target element to be created. Such a node is referred to herein as a primary content node (PCN) for the target model node. The source document subtrees that the PCN represents are the primary source of content for the target document subtrees represented by the corresponding node in the target model 118. In general, the target element may be instantiated once for each discriminated element in the source document found on the context path associated with the PCN. If all descendants of a target model node are source descendant nodes, the contents of the target document subtree rooted at the target model node are determined by the contents of the source document subtree corresponding to the target model node's PCN.

A target document subtree may contain additional content from other parts of the source document in addition to content associated with the PCN. This may occur whenever a node from the source model 116 is added to the target model 118 as a descendant of a non-local node. Such a node is referred to herein as a secondary content node (SCN). An SCN is not a descendant of the source model node that corresponds to its ancestor source node in the target model 118. Adding the SCN adds a new subtree to the target model 118 whose source elements are not drawn from the same source model subtree that gives rise to the nodes in the existing target model subtree. Adding SCNs creates composite subtrees in the target model 118 that contain both source nodes and source descendant nodes.

The semantics for transforming source documents to target documents for non-composite subtrees in the target model 118 may be straightforward. For each discriminated element in the source document for the PCN of the target model root node, starting at the root node of the target model subtree, an instance of the target element in the target document is created. This may be repeated recursively for each child of the root node. Because the source model 116 may include discriminators, the system 100 may use filtering at lower levels of the subtree rather than copying the entire subtree at once.

The semantics for composite subtrees may be more complex. When a subtree contains a source node, denoting elements to be populated from a different subtree of the source document, the source document may contain multiple instances of either or both of the subtrees. The system 100 may implement a rule for determining how subtree instances are matched to one another. In one embodiment, the rule matches each repeating instance of the PCN with SCN instances from a common subtree of the source document, which takes advantage of the natural relationship among elements in an XML hierarchy. The system 100 may implement other or additional rules.

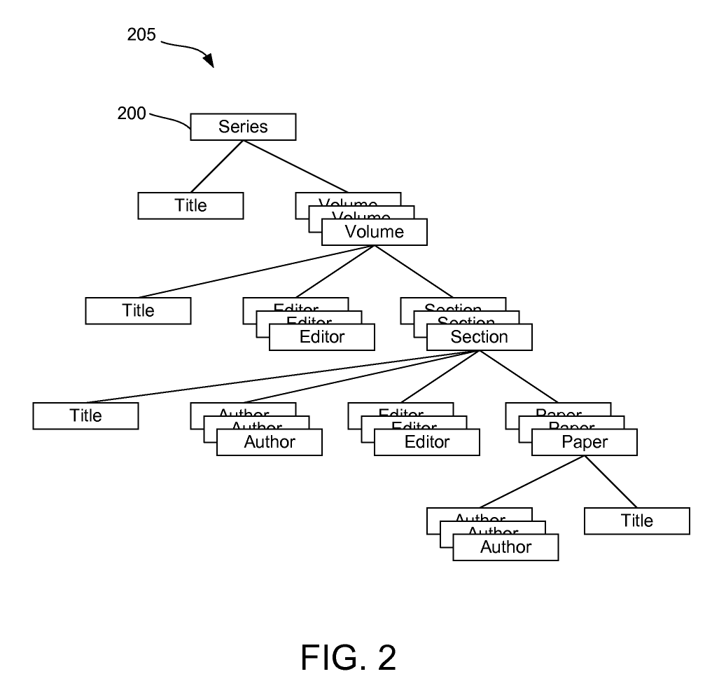

FIG. 2 depicts a schematic diagram of one embodiment of a document structure 205 conforming to a source XML schema 114. While the XML document transformation system 100 described herein is described in conjunction with the document structure 205 of FIG. 2, the XML document transformation system 100 may be used in conjunction with any document structure 205 or XML schema 114.

In one embodiment, the XML schema 114 includes a tree structure. While the XML schema 114 may represent any set of documents for the XML document transformation system 100, the XML schema 114 of FIG. 2 represents documents describing a series of books containing readings on various topics. In the present embodiment, various attributes and element content have been omitted for simplicity. Each document describes a series of books as a root node 200. A series may have one or more volumes, and each volume may have an editor and multiple sections. Some of the sections may be monographs with one or more authors, while others have one or more editors and contain several papers on a topic. The papers may further have one or more authors and a title. One of the authors may be designated as the contact author for a paper or section. Other configurations of the present XML schema 114 may include more or fewer nodes and/or elements associated with each node.

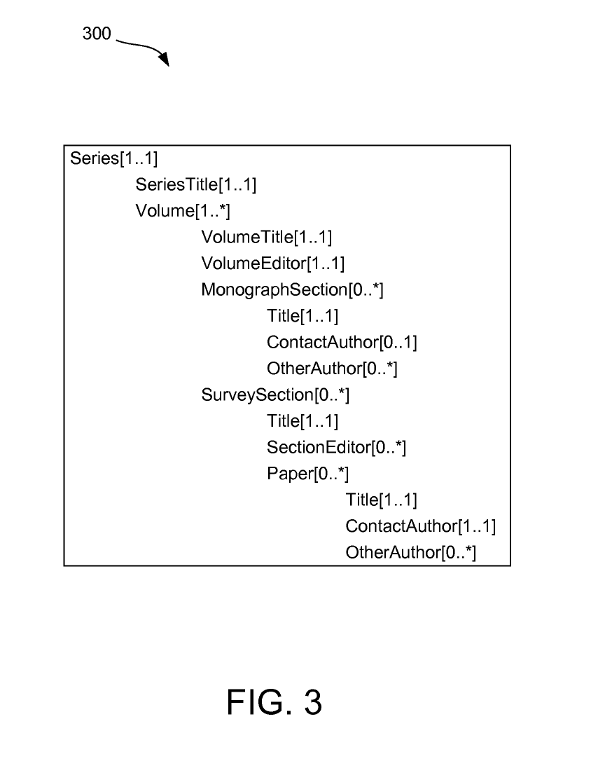

FIG. 3 depicts a schematic diagram of one embodiment of a semantic data structure 300 for the document structure 205 of FIG. 2. The source model 116 for the target model 118 may be represented by the semantic data structure 300. Discriminators are used for various elements in the semantic data structure 300 to give more descriptive names to various elements from the XML schema 114. For example, the semantic data structure 300 may include: SeriesTitle, SectionEditor, ContactAuthor, MonographSection, etc. In some embodiments, some of the elements in the semantic data structure 300 may be adjusted or altered from the element cardinalities in the XML schema 114—no document in the present embodiment of the semantic data structure 300 describes a volume with more than one editor. In some embodiments, the semantic data structure 300 for a collection of documents that conform to the XML schema 114 includes a hierarchy similar to or the same as the XML schema 114.

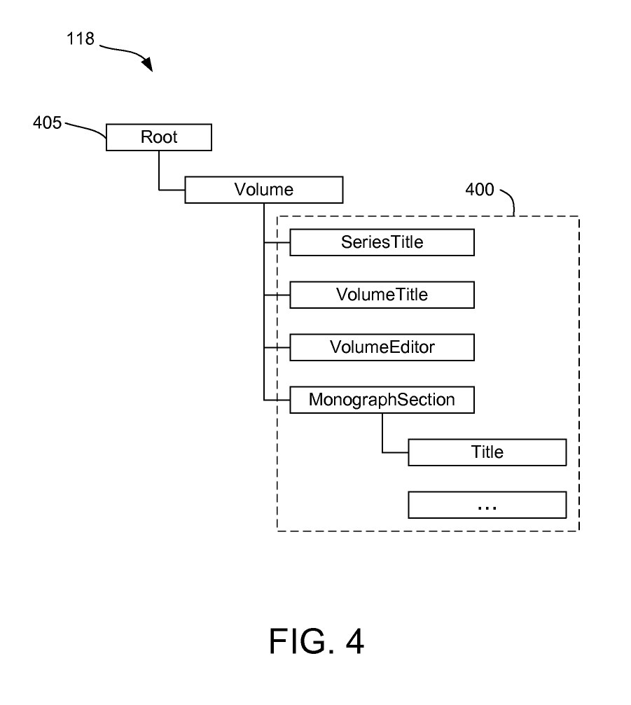

FIG. 4 depicts a schematic diagram of one embodiment of a target model 118. The user may add any of the elements from the source model 116 to the target model 118 to create a user-customized target XML schema 120. In one example, the user adds the “Volume” element from the semantic data structure 300 to the target model 118 that contains an initially empty root node 405. If no other elements are added, each transformed document contains one Volume element for each Volume element in the original document. For each such element, the entire subtree rooted at the source Volume element corresponding to the source model 116, as shown in FIG. 3, is copied to the target document. In such an embodiment, the structure under the Volume element in the target model 118 matches the structure of the Volume element in the source model 116.

In one embodiment, the user adds a SeriesTitle element from the semantic data guide to the target model 118, inserting the SeriesTitle element as a child of the Volume element, thereby making the Volume element a composite subtree 400, such that the Volume element subtree 400 in the target model 118 does not exactly match the structure of the Volume element in the source model 116. This addition to the target model 118 may also cause the subtree 400 rooted at the SeriesTitle element in the source model 116 to be added as a child of the Volume element for each volume in the series.

For the Volume element in the target model 118, the Volume element is the PCN from the semantic data guide, with context path Series/Volume. The Series/Title element, with context path Series/SeriesTitle, is a SCN for the Volume element in the target model 118.

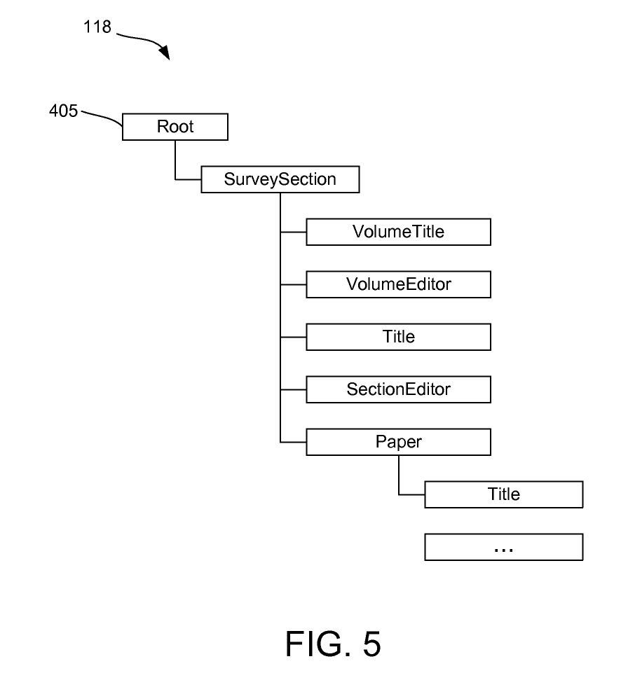

FIG. 5 depicts a schematic diagram of one embodiment of a target model 118. The target model 118 may be customized by the user to include any hierarchy or cardinality for the elements from the source model 116. In one embodiment, the user first adds the SurveySection element from the semantic data structure 300 to an empty root node 405. The user then adds the VolumeTitle element—found under the Volume element in the semantic data structure 300—as a child of the SurveySection element. The user also adds the VolumeEditor element as a child of the SurveySection element.

This produces a set of SurveySection elements covering survey sections from the entire series, each augmented with its corresponding volume title and volume editor. The mapping 122 generated by the system 100: 1) filters the Section elements in the generated XML schema so that those tagged with the SurveySection discriminator are selected, and 2) matches each SurveySection element with the proper VolumeTitle and VolumeEditor, i.e., those that share the same parent Volume element. In the present embodiment, the SurveySection element in the target model 118 corresponds to the PCN SurveySection from the source model 116, and the VolumeTitle element and the VolumeEditor element in the target model 118 correspond to the SCNs VolumeTitle and VolumeEditor from the source model 116. In more complex embodiments, filtering may be used for SCNs, target model elements may be renamed to increase clarity or avoid conflicts, unnecessary target model elements may be pruned or removed, and/or other operations may be performed on the target model 118 to further simplify or customize the target model 118.

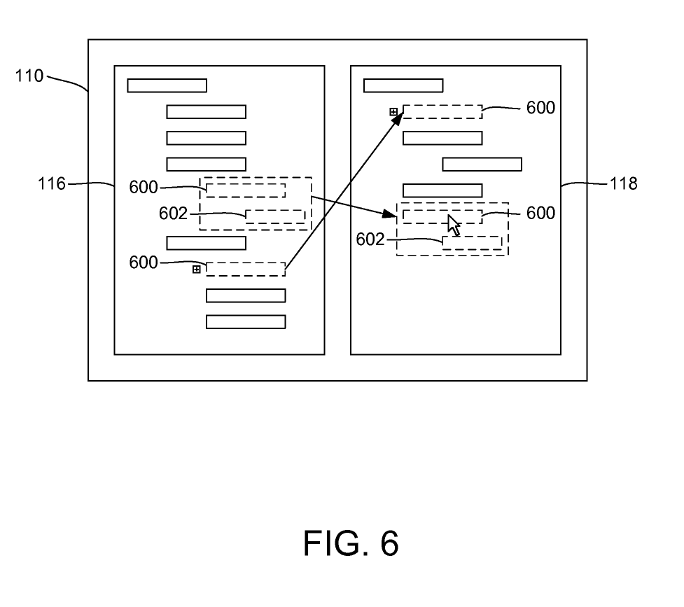

FIG. 6 depicts a schematic diagram of one embodiment of the user interface 110 of FIG. 1. While the XML document transformation system 100 described herein is described in conjunction with the user interface 110 of FIG. 6, the XML document transformation system 100 may be used in conjunction with any user interface 110.

Source elements 600 may be added to the target model 118 using a drag-and-drop user interface 110 in which a source element 600 is selected from the source model 116 and dropped into the desired location in the target model 118. In some embodiments, the source element 600 may be located in the source model 116 using a tree-structured view of the source model 116 or by searching a concept index built using discriminated element names.

In one embodiment, the user interface 110 displays the source model 116 and the target model 118 side-by-side, such that both models are visible to the user. The user may navigate each of the models separately or together. To create the target model 118, the user selects elements 600 from the source model 116 and drags the selected element 600 to the target model 118. The selected element 600 is then added to the target model 118 at the location chosen by the user. If the selected element 600 has any child nodes, the child nodes are moved to the target model 118 with the selected element 600, maintaining a hierarchy existing in the source model 116.

FIG. 7 depicts a flow chart diagram of one embodiment of a method 700 for simplifying the process of creating a transformation of the XML document transformation system 100 of FIG. 1. Although the method 700 is described in conjunction with the XML document transformation system 100 of FIG. 1, embodiments of the method 700 may be implemented with other types of XML document transformation systems 100.

In one embodiment, the system 100 creates 705 a target model 118 by incremental user selection of elements 600 in a source model 116. The source model 116 may correspond to a source XML schema 114 corresponding to one or more source documents. In some embodiments, the system 100 creates the target model 118 by allowing the user to select elements 600 from a semantic data structure 300 that represents a structural summary of the source documents and add the selected elements 600 to the target model 118. The semantic data structure 300 may include discriminated elements 600 corresponding to more general elements 600 in the XML schema. In one embodiment, the system 100 allows the user to move elements 600 from the source model 116 to the target model 118 using a drag-and-drop user interface 110.

In one embodiment, creating the target model 118 includes moving any sub-elements 602 of the selected element 600 in the source model 116 to the target model 118. The system 100 may also maintain a hierarchical structure or cardinality of the selected element 600 and its sub-elements 602. In some embodiments, the system 100 generates local nodes in the target model 118 that are not mapped to any elements 600 from the source model 116. The local nodes may be specific to the target documents to be created. The local nodes may be empty nodes into which non-local elements 600 from the source model 116 are inserted as sub-elements 602. The local nodes may be used to provide a specific layout or organization for the elements 600 in the target model 118.

The system 100 then interprets 710 the target model created by the user to automatically create a target XML schema 120 of the target model 118. The generated schema includes the elements 600 selected by the user and inserted into the target model 118. The schema also maintains a hierarchy of the elements 600 from the target model 118. The target schema 120 uses XML-based terminology and is able to be used to create XML documents.

After the XML schema has been generated from the target model 118, the system 100 generates 715 a mapping 122 between the source schema 114 of the XML document and the target schema 120. The mapping 122 may be stored in a memory device for use in generating XML documents using the target model 118. In one embodiment, the system 100 then maps 720 part or all of the content or attributes of the target model 118 into a relational model to simplify the structure of the target model 118. The relational model may be a flat table, rather than a structure with nested elements 600. In some embodiments, the relational model may include one or more tables. The tables may include primary-and-foreign key relationships that correspond to the hierarchy of the target model 118.

In one embodiment, the system 100 finds a number of instances of the selected element 600 in a source document corresponding to the source model 116 and generates a number of instances of the selected element 600 in a target document corresponding to the target model 118 based on the number of instances in the source document. The system 100 also determines a position for each of the instances of the element 600 in the mapping 122 based on a heuristics analysis of the source model 116. The heuristics analysis may determine a likelihood that the element 600 corresponds to another element 600 based on the proximity of the elements 600 to each other.

In one embodiment, the system 100 uses rules that describe how an SCN contributes to a subtree 400 rooted at a given target model node. A rule may determine the probable least common ancestor of the target model subtree's PCN and the SCN. Because a semantic data structure 300 may be a summary of many documents, the least common ancestor of two nodes in the semantic data structure 300 may not be the least common ancestor of the two nodes in any document in which they appear.

For example, the common ancestor in the semantic data structure 300 may occur multiple times in source documents, but both nodes of interest may never occur as descendants of any single instance of the apparent common ancestor. In such an example, a Volume element 600 may contain only MonographSection elements 600 or SurveySections, but not both. Consequently, the actual least common ancestor occurs farther up the hierarchy at some node that is a common ancestor of all the instances of the apparent common ancestor. In one embodiment, the semantic data structure 300 includes limited information about which child nodes coexist in the same document, allowing the system 100 to infer when it needs to look further up the hierarchy for the probable least common ancestor.

In one embodiment, a rule may determine that for each instance of the discriminated element 600 in the source model 116 that corresponds to the PCN of the target model node, the system 100 maps the discriminated elements 600 corresponding to the SCN that are descendants of the probable least common ancestor into the PCN's subtree 400.

In one embodiment, when the user specifies the source context paths and their desired locations in the target model 118, the system 100 may automatically generate the target XML schema and the correspondences and conditions that make up the mapping 122 from the source schema 114 to the target schema 120. The mapping infrastructure may support conditional execution and the ability to filter mapped elements 600.

In one embodiment, the mapping infrastructure supports the following specific types of mappings:
1) Move Map: a mapping that represents the transfer of an atomic data element from source to target, subject to a condition.
2) Local Map: a mapping that represents the transfer of a compound data element from source to target, subject to a condition. A Local Map is implemented by a set of nested mappings between sub-elements of the source and target elements.
3) ForEach Map: a mapping that represents the transfer from source to target of selected instances of a repeating element, subject to an optional filtering condition. Like a Local Map, a ForEach Map is implemented by a set of nested mappings. A ForEach mapping has one primary input and may have zero or more secondary inputs. The primary input designates the repeating source element and, via iteration subject to a filter, determines the number of target elements created. Secondary inputs designate additional elements that are available to the implementation of the mapping for use in the construction of target elements.
4) Join Map: a mapping that selectively combines data from multiple source elements to produce target elements. A Join Map is also implemented as a set of nested mappings. A Join mapping has two or more primary inputs, and zero or more secondary inputs. The primary inputs designate repeating source elements that are combined to produce one or more target elements. Conditions may be supplied to filter any of the primary inputs, or to control the matching of elements from different primary inputs, in a manner similar to the relational join operator. As in ForEach mappings, secondary inputs designate additional elements that are available to the implementation of the mapping for use in the construction of target elements.

The algorithm for generating a mapping 122 from a target model 118 and an SDG has two parts. In the first part, the XML schema for target documents is generated. The algorithm for generating the target schema 120 is given by the function genXSDComponent.( ) below, which takes a target mode node N as an argument.
1) Create global set Pool_{XSD} and global target schema XSD_{T}. Both are initially empty.
2) Call function genXSDComponent(R), where R is the root of the target model.
3) Add the returned element declaration ElemDecl_{R} to XSD_{T}.

Function genXSDComponent(TargetModelNode N) is shown below:
1. From the Semantic Data Guide, determine CP_{N}, the context path for node N.
2. Create empty sets AttrDeclSet_{N} and ElemDeclSet_{N}.
3. For each attribute A of node N
   1. Look up the original data type T_{A} in the SDG using the context path information, CP_{N}, and the source XML schema.
   2. Look up the minimum cardinality of the attribute in the SDG (it may be either 0 or 1).
   3. Create an attribute declaration AttrDecl_{A} and assign the original type, T_{A}, to the attribute declaration. If the attribute's minimum cardinality is 0, make the attribute optional.
   4. Add AttrDecl_{A} to the attribute declaration set, AttrDeclSet_{N}.
4. For each child node C of N
   1. Recursively call genXSDComponent(C), which will generate the corresponding child element declaration, ElemDecl_{C}.
   2. Add ElemDecl_{C} to ElemDeclSet_{N}.
5. Given the attribute declaration set, AttrDeclSet_{N} and the element declaration set, ElemDeclSet_{N}, find whether there is any schema type in Pool_{XSD} with sets that contain the same members.
   1. If so, let T_{N} be the matching type from Pool_{XSD}.
   2. If not, let T_{N} be a new type definition with attributes and elements as specified by sets AttrDecl_{A} and ElemDecl_{C}, and add it to XSD_{T} and Pool_{XSD}.
6. Look up the minimum and maximum cardinality of the element in the SDG.
7. Create an element declaration ElemDecl_{N}, and set its name to the name of node N.
8. If the minimum cardinality from the SDG is 0, set the minimum cardinality of the new element to 0, otherwise set it to 1. If the maximum cardinality from the SDG is >1, set the maximum cardinality of the element to “unbounded”, otherwise set it to 1.
9. Assign type T_{N} to ElemDecl_{N}.
10. Return ElemDecl_{N}.

In the second part of the algorithm, a mapping 122 is generated from the source schema 114 to the target schema 120. The details of this algorithm depend on the nature of the underlying mapping infrastructure. The description below corresponds to the infrastructure described above and uses a Semantic Data Guide (SDG) as the semantic data structure 300. The algorithm for generating the mapping 122 is expressed by the recursive procedure implementMapping, which is initially invoked on the root node 405 of the target schema 120 and recursively invoked for each descendant element 600 in the target schema 120. The utility procedure createMapping creates a mapping 122 given a set of inputs. A description of createMapping follows the description of implementMapping.

Procedure implementMapping(currentMapping, currentSDGNode, currentInputs, currentTarget):
1. For each element newTarget that is a child of currentTarget in the target model

A. If newTarget is a Local Node:
1. Copy currentInputs to newInputs
2. newSDGNode=currentSDGNode
3. newMapping=createMapping(newnIputs, newTarget)
4. add newMapping as a child of currentMapping
5. recursively call:
   implementMapping(newMapping, newSDGNode, newInputs, newTarget).

Otherwise (newTarget is a Source or Source Descendant Node):
1. Find an ancestor of newTarget that is not a local node.
2. If none exists, select all context paths associated with newTarget
Otherwise, among all context paths associated with newTarget, find the context path for which the common ancestor of the context path's SDG node and currentSDGNode is the least distance above currentSDGNode. In case of ties, choose the context path whose SDG node is the smallest distance below the common ancestor. (The SDG node(s) associated with the chosen context path(s) are the Primary Content Nodes for newTarget.)
3. For each Primary Content Node found in step 2:
   A. Find the closest iterable ancestor of the Primary Content Node on the path between it and currentSDGNode, if one exists. If none exists, the Primary Content Node itself. This is the Gateway Node for the Primary Content Node.
   B. Create a new input describing the path from currentSDGNode to the Gateway Node.
   C. Add conditions for discriminators associated with SDG nodes on the path between currentSDGNode and the Primary Content Node.
   D. For each Secondary Content Node associated with newTarget:
      1. Find the probable common ancestor between the Secondary Content Node and the Primary Content Node.
      2. If the probable common ancestor is not a descendant of the Gateway Node:
         a. If currentMapping has an input for the Secondary Content Node, copy it to newInputs. Otherwise (need to create an additional input):
         1. Find the least iterable ancestor of the Secondary Content Node on the path between it and currentSDGNode, if one exists. If none exists, choose the Secondary Content Node itself. This is the Gateway Node for the Secondary Content Node.
         2. Create a new input describing the path from currentSDGNode to the Gateway Node.
      3. If the Secondary Content Node is iterable:
         a. Add conditions for discriminators associated with SDG nodes on the path between currentSDGNode and the Secondary Content Node.
         b. If the Primary Content Node is iterable:
         1. Find the probable common ancestor between the Secondary Gateway Node and the Primary Gateway Node. If this probable common ancestor is above the common ancestor of the Primary and Secondary Content Nodes, use this node instead.
         2. Create a join condition that requires that the Primary and Secondary Content Nodes share the selected common ancestor.
         4. Add the new input to newInputs
      4. newMapping=createMapping(newInputs, newTarget)
      5. Add newMapping as a child of currentMapping
      6. Recursively call:
         implementMapping(newMapping, primaryContentNode, newInputs, newTarget)
   2. For each attribute that is a child of currentTarget, create a Move mapping from the corresponding child attribute of currentSDGNode.
   3. If the node type of currentSDGNode allows mixed content, create a Move mapping from the content of currentSDGNode to the content of currentTarget.
   Procedure createMapping(inputs, target):
   If there is more than one input:
      If more than one input is iterable:
         1. Create a Join mapping
         2. Make the iterable inputs primary inputs,
         3. Make the other inputs secondary inputs
      Otherwise, if exactly one input is iterable:
         1. Create a ForEach mapping
         2. Make the iterable input the primary input
         3. Make the other inputs secondary inputs
      Otherwise (no inputs are iterable):
         1. Create a Local Map mapping
         2. Make the first input the primary input
         3. Make the other inputs secondary inputs
      Otherwise (exactly one input):
         If the input is iterable:
         Create a ForEach mapping with one input
         Otherwise, if the input node type is a simple type:
         Create a Move mapping with one input
         Otherwise:
         Create a Local Map mapping with one input
   Make the output of the new mapping the target node
   Return the new mapping

An embodiment of an XML document transformation system 100 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation for simplifying a process for creating a transformation of an XML document.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. A computer readable storage medium or device is a specific type of computer-readable or -usable medium. Examples of a computer-readable storage medium include a semiconductor or solid state memory, magnetic tape, a removable computer diskette, a random access memory (RAM), a read-only memory (ROM), a rigid magnetic disk, and an optical disk. Hardware implementations including computer readable storage media also may or may not include transitory media. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types 124 of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for creating a transformation of an extensible markup language (XML) document, comprising:
creating a target model by incremental user selection of elements in a source model;
interpreting the target model to create an XML schema of the target model; and
creating a mapping between the source model of the XML document and the target model, wherein the mapping is stored on a memory device.

2. The method of claim 1, wherein creating the target model further comprises:
selecting an element from a semantic data structure, wherein the semantic data structure represents a structural summary of source documents for the source model; and
adding the element to the target model.

3. The method of claim 1, wherein creating the target model further comprises:
moving the element from the source model to the target model in a drag-and-drop user interface.

4. The method of claim 1, wherein creating the target model further comprises:
moving a sub-element of the element in the source model to the target model; and
maintaining a hierarchical structure of the element and the sub-element.

5. The method of claim 1, wherein creating the target model further comprises:
generating a local node in the target model, wherein the local node is not mapped to any elements from the source model; and
adding the element from the source model as a sub-element to the local node in the target model.

6. The method of claim 1, further comprising:
transforming the target model into a relational model.

7. The method of claim 1, further comprising:
finding a number of instances of the element in a source document corresponding to the source model;
generating the number of instances of the element in a target document corresponding to the target model; and
determining a position for each of the instances in the mapping of the target model based on a heuristics analysis of the source model.
